(19) United States
(12) Patent Application Publication
(10) Pub. No.: US 2018/0091031 A1
(43) Pub. Date: Mar. 29, 2018

(54) RELUCTANCE GENERATOR

(71) Applicants: Fu-Tzu HSU, Taipei City (TW); Chieh-Sen TU, New Taipei City (TW)

(72) Inventors: Fu-Tzu HSU, Taipei City (TW); Chieh-Sen TU, New Taipei City (TW)

(21) Appl. No.: 15/711,681

(22) Filed: Sep. 21, 2017

(30) Foreign Application Priority Data
Sep. 23, 2016 (TW) 105130717

(51) Int. Cl. H02K 19/24; H02K 1/24; H02K 1/14; H02K 19/32; H02K 11/04

(52) U.S. Cl. CPC H02K 19/24; H02K 1/246; H02K 11/046; H02K 19/32; H02K 1/146

(57) ABSTRACT

A reluctance generator includes a circular stator made by silicon steel sheets and amorphous metal, first and second exciting coils, first and second outputting coils, and a rotator disposed in the stator. The stator includes four projecting poles. Two opposite ones and the other two opposite ones of the projecting poles are respectively formed with first and second teeth at distal ends thereof. The first exciting coil, the first outputting coil, the second exciting coil and the second outputting coil are in sequence and each wound around the stator between respective two adjacent ones of the projecting poles. When the rotator rotates, the first and second teeth are alternately aligned with third teeth that surround the rotator.

### CROSS-REFERENCE TO RELATED APPLICATION

This application claims priority of Taiwanese Patent Application No. 105130717, filed on Sep. 23, 2016.

### FIELD

The disclosure relates to a generator, and more particularly to a reluctance generator.

### BACKGROUND

A conventional switched reluctance generator (SR generator) is configured to convert mechanical energy into electrical energy with a switching circuit thereof controlling conduction between each winding set and an energy storage device of the conventional SR generator, so as to switch a direction at which electrical energy flows between the winding set and the energy storage device. To generate the electrical energy, the conventional SR generator allows conduction from the energy storage device to a winding set via the switching circuit, such that the winding set is energized by the energy storage device. To charge the energy storage device, the conventional SR generator allows conduction from the winding set to the energy storage device via the switching circuit, such that an electrical current generated in the winding set flows from the winding set to the energy storage device. Therefore, the switching circuit is indispensable to implement the conventional SR generator.

### SUMMARY

Therefore, an object of the disclosure is to provide a reluctance generator that omits a switching circuit and that can alleviate at least one of the drawbacks of the prior art.

According to the disclosure, the reluctance generator includes a stator, a first exciting coil, a second exciting coil, a first outputting coil, a second outputting coil and a rotator. The stator is substantially circular in shape, and includes four projecting poles that extend inwardly and radially and that are equally spaced apart from each other. Two opposite ones of the projecting poles are formed with a plurality of first teeth at distal ends of the two opposite ones of the projecting poles. The other two opposite ones of the projecting poles are formed with a plurality of second teeth at distal ends of said the other two opposite ones of the projecting poles. The stator is a composite core that is made of silicon steel sheets and amorphous metal. The first exciting coil is wound around the stator between two adjacent ones of the projecting poles. The second exciting coil is wound around the stator between the other two adjacent ones of the projecting poles, and is disposed opposite to the first exciting coil. The first outputting coil is wound around the stator between two adjacent ones of the projecting poles that are adjacent to the first exciting coil and the second exciting coil, respectively. The second outputting coil is wound around the stator between the other two adjacent ones of the projecting poles that are respectively adjacent to the first exciting coil and the second exciting coil, and is disposed opposite to the first outputting coil. The rotator is disposed in the stator, and is formed with a plurality of third teeth surrounding the rotator and facing the stator, in such a manner that the first teeth and the second teeth are alternately aligned with the third teeth when the rotator rotates in the stator.

### BRIEF DESCRIPTION OF THE DRAWINGS

Other features and advantages of the disclosure will become apparent in the following detailed description of the embodiment with reference to the accompanying drawings, of which:

FIG. 1 is a schematic diagram illustrating an embodiment of a reluctance generator according to the disclosure;

FIG. 2 is a schematic diagram illustrating one embodiment that first and second magnetic fluxes are generated when first teeth and third teeth of the reluctance generator are aligned with each other;

FIG. 3 is a schematic diagram illustrating the embodiment that third and fourth magnetic fluxes are generated when second teeth and third teeth of the reluctance generator are aligned with each other;

FIG. 4 is a schematic diagram illustrating one embodiment that first and second outputting coils of the reluctance generator are electrically connected to a storage circuit; and

FIG. 5 is a circuit diagram illustrating an embodiment of the storage circuit of the reluctance generator according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics. In addition, when two elements are described as being “coupled in series,” “connected in series” or the like, it is merely intended to portray a serial connection between the two elements without necessarily implying that the currents flowing through the two elements are identical to each other and without limiting whether or not an additional element is coupled to a common node between the two elements. Essentially, “a series connection of elements,” “a series coupling of elements” or the like as used throughout this disclosure should be interpreted as being such when looking at those elements alone.

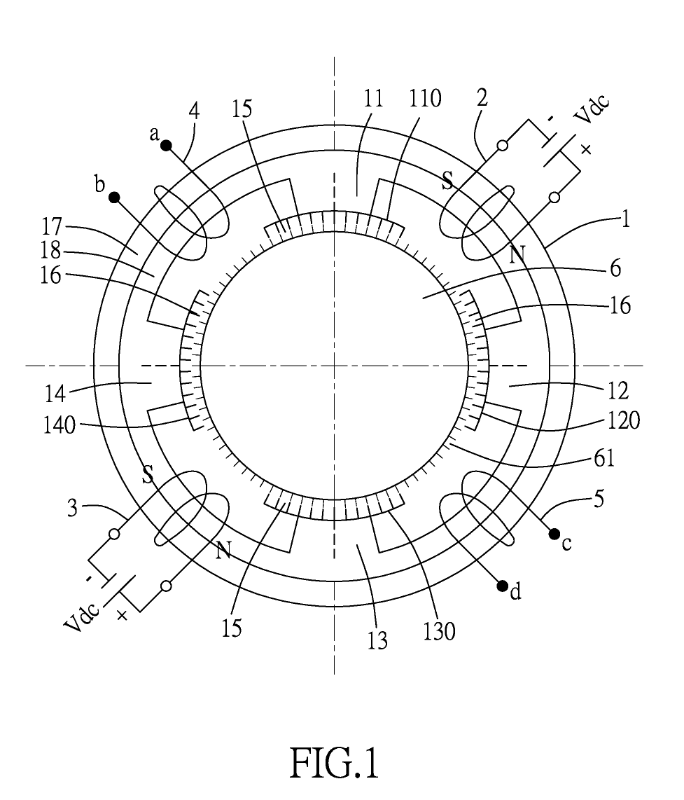

Referring to FIGS. 1 to 3, an embodiment of a reluctance generator with mechanical commutation according to the disclosure is illustrated. The reluctance generator includes a stator 1, a first exciting coil 2, a second exciting coil 3, a first outputting coil 4, a second outputting coil 5 and a rotator 6.

The stator 1 is substantially circular in shape, and includes four projecting poles 11-14 that extend inwardly and radially and that are equally spaced apart from each other. Two opposite ones of the projecting poles 11, 13 are formed with a plurality of first teeth 15 at distal ends of the two opposite ones of the projecting poles 11, 13. The other two opposite ones of the projecting poles 12, 14 are formed with a plurality of second teeth 16 at distal ends of said the other two opposite ones of the projecting poles 12, 14. Specifically, the distal ends of the two opposite ones of the projecting poles 11, 13 are respectively formed with expanded portions 110, 130 that are substantially arc-shaped and that have the first teeth 15 disposed thereon. Likewise, the distal ends of said the other two opposite ones of the projecting poles 12, 14 are respectively formed with expanded portions 120, 140 that are substantially arc-shaped and that have the second teeth 16 disposed thereon. The stator 1 is a composite core that is made of a set of silicon steel sheets 17 and amorphous metal 18. As shown in FIG. 1, the set of silicon steel sheets 17 constitutes an outer part of the stator 1, and the amorphous metal 18 constitutes an inner part of the stator 1. However, implementation of the stator 1 may vary in other embodiments, such as that the set of silicon steel sheets 17 constitutes the inner part of the stator 1, and the amorphous metal 18 constitutes the outer part of the stator 1.

The first exciting coil 2 is wound around the stator 1 between two adjacent ones of the projecting poles 11, 12. The second exciting coil 3 is wound around the stator 1 between the other two adjacent ones of the projecting poles 13, 14, and is disposed opposite to the first exciting coil 2. The first outputting coil 4 is wound around the stator 1 between two adjacent ones of the projecting poles 11, 14 that are adjacent to the first exciting coil 2 and the second exciting coil 3, respectively. The second outputting coil 5 is wound around the stator 1 between the other two adjacent ones of the projecting poles 12, 13 that are respectively adjacent to the first exciting coil 2 and the second exciting coil 3, and is disposed opposite to the first outputting coil 4.

The rotator 6 is disposed in the stator 1, and is formed with a plurality of third teeth 61 being equally spaced apart from each other, surrounding the rotator 6 and facing the stator 1, in such a manner that the first teeth 15 and the second teeth 16 are alternately aligned with the third teeth 61 when the rotator 6 rotates in and with respect to the stator 1. In other words, when the first teeth 15 are aligned with the third teeth 61, the second teeth 16 are staggered with the third teeth 61; when the second teeth 16 are aligned with the third teeth 61, the first teeth 15 are staggered with the third teeth 61. It is worth to note that the rotator 6 may be driven by a motor (not shown) to rotate.

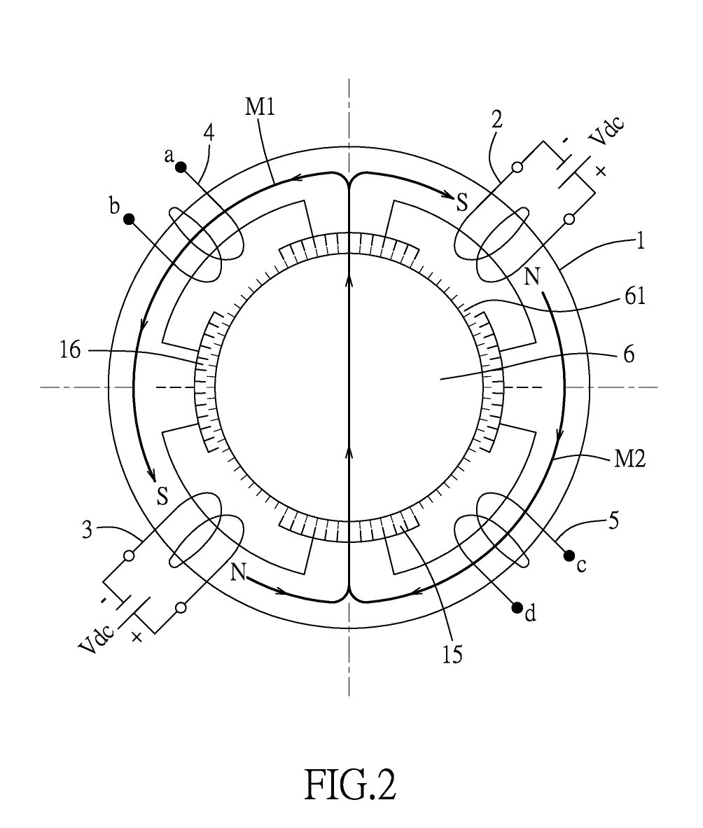

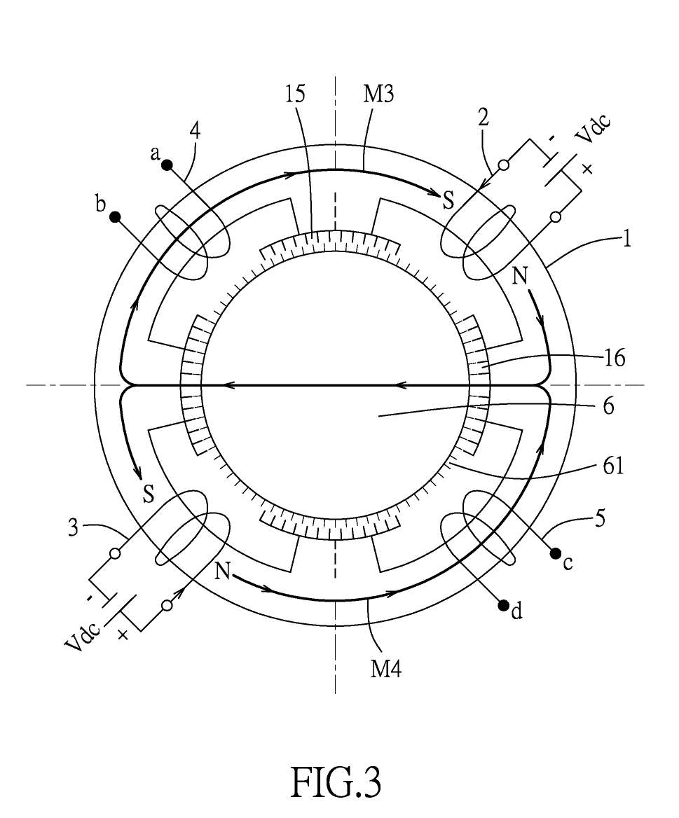

Referring to FIG. 1, the first exciting coil 2 is configured to be powered by a direct current (DC) electrical source (Vdc) so as to form a first magnetic field. The second exciting coil 3 is configured to be powered by the DC electrical source (Vdc) as well so as to form a second magnetic field, which and the first magnetic field repel each other. Therefore, referring to FIG. 2, when the first teeth 15 are brought to be aligned with the third teeth 61 by rotation of the rotator 6, the second teeth 16 are staggered with the third teeth 61. Meanwhile, a first magnetic flux (M1) passing through the first outputting coil 4 and a second magnetic flux (M2) passing through the second outputting coil 5 are generated by the first magnetic field and the second magnetic field to follow a magnetic path formed between the stator 1 and the rotator 6 via the first teeth 15 and the third teeth 61 which are aligned with each other. Referring to FIG. 3, when the second teeth 16 are brought to be aligned with the third teeth 61 by rotation of the rotator 6, the first teeth 15 are staggered with the third teeth 61. In the meantime, a third magnetic flux (M3) passing through the first outputting coil 4 and a fourth magnetic flux (M4) passing through the second outputting coil 5 are generated by the first magnetic field and the second magnetic field to follow a magnetic path formed between the stator 1 and the rotator 6 via the second teeth 16 and the third teeth 61 which are aligned with each other. The third magnetic flux (M3) is opposite in direction to the first magnetic flux (M1) to result in an eddy current on the first outputting coil 4. The fourth magnetic flux (M4) is opposite in direction to the second magnetic flux (M2) to result in another eddy current on the second outputting coil 5. In consequence, when the rotator 6 keeps rotating, the eddy currents are generated on the first and second outputting coils 4, 5 due to alternating magnetic fluxes passing therethrough (i.e., the first and third magnetic fluxes M1, M3 for the first outputting coil 4, and the second and fourth magnetic fluxes M2, M4 for the second outputting coil 5).

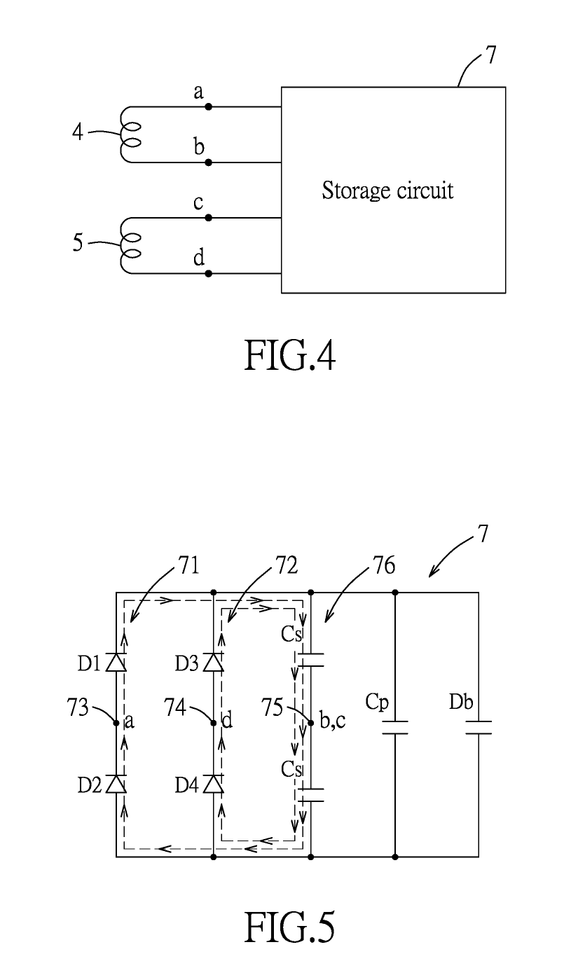

To rectify the eddy currents from the first and second outputting coils 4, 5 and to store the same, as illustrated in FIG. 4, the embodiment of the reluctance generator further includes a storage circuit 7 that is electrically connected to the first outputting coil 4 and the second outputting coil 5 so as to receive the eddy currents therefrom for storage as electrical energy.

Specifically speaking, referring to FIG. 5, the storage circuit 7 includes a first flyback diode set 71, a second flyback diode set 72, a non-polar capacitor set 76, a secondary battery (Db) and a polar capacitor (Cp). The first flyback diode set 71 includes a first flyback diode (D1) and a second flyback diode (D2) that are connected in series at a first node 73, which is further connected to an end (a) of the first outputting coil 4. The second flyback diode set 72 is connected in parallel with the first flyback diode set 71, and includes a third flyback diode (D3) and a fourth flyback diode (D4) that are connected in series at a second node 74, which is further connected to an end (d) of the second outputting coil 5. The non-polar capacitor set 76 is connected in parallel with the first flyback diode set 71, and includes two non-polar capacitors (Cs) that are connected in series at a third node 75, which is further connected together with the other end (b) of the first outputting coil 4 and the other end (c) of the second outputting coil 5. The secondary battery (Db) is connected in parallel with the first flyback diode set 71. The polar capacitor (Cp) is connected in parallel with the first flyback diode set 71, and is configured to charge the secondary battery (Db). In one embodiment, when the storage circuit 7 is in operation, the polar capacitor (Cp) has a positive terminal (i.e., an anode) connected to cathodes of the first and second flyback diodes (D1 and D3), and a negative terminal (i.e., a cathode) connected to anodes of the third and fourth flyback diodes (D2 and D4). The polar capacitor (Cp) may be implemented by a super capacitor or an electrolytic capacitor. The non-polar capacitors (Cs) are implemented by capacitors that are suitable for high frequency applications. The polar capacitor (Cp) and the non-polar capacitors (Cs) cooperate to store electrical energy. Details of the combination of the polar capacitor (Cp) and the non-polar capacitors (Cs) may be found in Taiwanese Utility Model Patent No. M477033, and disclosures of which are incorporated herein by reference.

Referring to FIGS. 4 and 5, the first outputting coil 4 is configured to charge the non-polar capacitor set 76 by the eddy current flowing from the first outputting coil 4 through one of the first flyback diode (D1) (i.e., the eddy current is outputted at the end (a) of the first outputting coil 4) and the second flyback diode (D2) (i.e., the eddy current is outputted at the end (b) of the first outputting coil 4) to the non-polar capacitor set 76. The second outputting coil 5 is configured to charge the non-polar capacitor set 76 by the eddy current flowing from the second outputting coil 5 through one of the third flyback diode (D3) (i.e., the eddy current is outputted at the end (d) of the second outputting coil 5) and the fourth flyback diode (D4) (i.e., the eddy current is outputted at the end (c) of the second outputting coil 5) to the non-polar capacitor set 76. Charges accumulated on the non-polar capacitor set 76 redistribute to the polar capacitor (Cp) and the secondary battery (Db), thereby storing electrical energy in the secondary battery (Db).

Moreover, the secondary battery (Db) is configured to be connected in parallel with the DC electrical source (Vdc) (see FIG. 1) for providing electrical energy to the first exciting coil 2 and the second exciting coil 3. In this embodiment, the secondary battery is implemented by a battery with damping function.

In summary, two opposite ones of the projecting poles 11, 13 are formed with the first teeth 15 at the distal ends of the two opposite ones of the projecting poles 11, 13. The other two opposite ones of the projecting poles 12, 14 are formed with the second teeth 16 at the distal ends of said the other two opposite ones of the projecting poles 12, 14. The first exciting coil 2 is wound around the stator 1 between two adjacent ones of the projecting poles 11, 12. The second exciting coil 3 is wound around the stator 1 between the other two adjacent ones of the projecting poles 13, 14, and is disposed opposite to the first exciting coil 2. The first outputting coil 4 is wound around the stator 1 between two adjacent ones of the projecting poles 11, 14. The second outputting coil 5 is wound around the stator 1 between the other two adjacent ones of the projecting poles 12, 13, and is disposed opposite to the first outputting coil 4. The rotator 6 is formed with the third teeth 61 surrounding the rotator 6 and facing the stator 1, in such a manner that the first teeth 15 and the second teeth 16 are alternately aligned with the third teeth 61 when the rotator 6 rotates in the stator 1. As a result, when the rotator 6 keeps rotating, the eddy currents are generated on the first and second outputting coils 4, 5 due to alternating magnetic fluxes passing therethrough. The storage circuit 7, which is electrically connected to the first outputting coil 4 and the second outputting coil 5, receives the eddy currents and stores the same as electrical energy in the storage circuit 7.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A reluctance generator comprising:
a stator being substantially circular in shape, and including four projecting poles that extend inwardly and radially and that are equally spaced apart from each other, two opposite ones of said projecting poles being formed with a plurality of first teeth at distal ends of said two opposite ones of said projecting poles, the other two opposite ones of said projecting poles being formed with a plurality of second teeth at distal ends of said the other two opposite ones of said projecting poles, said stator being a composite core that is made of silicon steel sheets and amorphous metal;
a first exciting coil wound around said stator between two adjacent ones of said projecting poles;
a second exciting coil wound around said stator between the other two adjacent ones of said projecting poles, and being disposed opposite to said first exciting coil;
a first outputting coil wound around said stator between two adjacent ones of said projecting poles that are adjacent to said first exciting coil and said second exciting coil, respectively;
a second outputting coil wound around said stator between the other two adjacent ones of said projecting poles that are respectively adjacent to said first exciting coil and said second exciting coil, and being disposed opposite to said first outputting coil; and
a rotator disposed in said stator, and being formed with a plurality of third teeth surrounding said rotator and facing said stator, in such a manner that said first teeth and said second teeth are alternately aligned with said third teeth when said rotator rotates in said stator.

2. The reluctance generator as claimed in claim wherein:
said first exciting coil is configured to be powered by a direct current (DC) electrical source so as to form a first magnetic field;
said second exciting coil is configured to be powered by the DC electrical source so as to form a second magnetic field, which and the first magnetic field repel each other;
when said first teeth are aligned with said third teeth, said second teeth are staggered with said third teeth, a first magnetic flux passing through said first outputting coil and a second magnetic flux passing through said second outputting coil being generated by the first magnetic field and the second magnet field to follow a magnetic path formed between said stator and said rotator via said first teeth and said third teeth which are aligned with each other; and
when said second teeth are aligned with said third teeth, said first teeth are staggered with said third teeth, a third magnetic flux passing through said first outputting coil and a fourth magnetic flux passing through said second outputting coil being generated by the first magnetic field and the second magnet field to follow a magnetic path formed between said stator and said rotator via said second teeth and said third teeth which are aligned with each other, the third magnetic flux being opposite in direction to the first magnetic flux to result in an eddy current on said first outputting coil, the fourth magnetic flux being opposite in direction to the second magnetic flux to result in another eddy current on said second outputting coil.

3. The reluctance generator as claimed in claim 2, further includes a storage circuit that is electrically connected to said first outputting coil and said second outputting coil so as to receive the eddy currents therefrom for storage as electrical energy in said storage circuit.

4. The reluctance generator as claimed in claim 3, wherein:
said storage circuit includes:
a first flyback diode set including a first flyback diode and a second flyback diode that are connected in series at a first node, which is further connected to an end of said first outputting coil,
a second flyback diode set connected in parallel with said first flyback diode set, and including a third flyback diode and a fourth flyback diode that are connected in series at a second node, which is further connected to an end of said second outputting coil,
a non-polar capacitor set connected in parallel with said first flyback diode set, and including two non-polar capacitors that are connected in series at a third node, which is further connected together with the other end of said first outputting coil and the other end of said second outputting coil,
a secondary battery connected in parallel with said first flyback diode set, and
a polar capacitor connected in parallel with said first flyback diode set, and configured to charge said secondary battery;
said first outputting coil is configured to charge said non-polar capacitor set by the eddy current flowing from said first outputting coil through one of said first flyback diode and said second flyback diode to said non-polar capacitor set; and
said second outputting coil is configured to charge said non-polar capacitor set by the eddy current flowing from said second outputting coil through one of said third flyback diode and said fourth flyback diode to said non-polar capacitor set.

5. The reluctance generator as claimed in claim 4, wherein said secondary battery is configured to be connected in parallel with the DC electrical source.

6. The reluctance generator as claimed in claim 4, wherein said secondary battery is a battery with damping function.
